(19) United States
(12) Patent Application Publication
(10) Pub. No.: US 2013/0328835 A1
(43) Pub. Date: Dec. 12, 2013

(54) OPTICAL TOUCH PANEL

(71) Applicant: Tae Young Ahn, Donghae-si (KR)

(72) Inventor: Tae Young Ahn, Donghae-si (KR)

(73) Assignee: EASTSEA INSTITUTE FOR APPLIED SCIENCE AND TECHNOLOGY, Donghaesi Kangwondo (KR)

(21) Appl. No.: 13/994,531

(22) PCT Filed: Dec. 14, 2011
(86) PCT No.: PCT/KR11/09613

§ 371 Date: Aug. 8, 2013

(30) Foreign Application Priority Data
Dec. 15, 2010 (KR) 10-2010-0128092

(51) Int. Cl. G06F 3/042

(52) U.S. Cl. CPC G06F 3/042
USPC 345/175

(57) ABSTRACT

Disclosed is an optical touch panel touched by an infrared light in a remote place without a physical touch.

The optical touch panel includes a light transmission screen imaging an infrared light incident into a front surface thereof and scattering the infrared light along the front surface, and transmitting a visible light incident into a rear surface thereof to the front surface, a first infrared light sensor module provided at a lateral side of the light transmission screen and including a plurality of infrared light sensors to detect energy of the infrared light that has been scattered, a second infrared light sensor module provided at a lateral side of a light transmission panel in such a manner that a position of the second infrared light sensor module is different from a position of the first infrared light sensor module, and including a plurality of infrared light sensors to detect energy of the infrared light that has been scattered, and an operation module calculating an imaging position of the infrared light based on electrical signals output from the infrared light sensors of the first infrared light sensor module and electrical signals output from the infrared light sensors of the second infrared light sensor module.

### BACKGROUND OF THE INVENTION

1. Field of the Invention

The present invention relates to an optical touch panel. In more particular, the present invention relates to an optical touch panel which can be touched by an infrared light without a physical touch.

2. Description of the Related Art

Recently, with the rapid advance of software, semiconductor technologies, and information processing technologies, various information appliances such as cellar phones, PDAs, and computers have been multi-functioned. In addition, the importance of information storage and communication based on data input has been increased in the information appliances.

Conventionally, data are input into the information appliance by pressing input keys. However, recently, data input into the information appliance through a touch screen has been increased.

In general, the touch screen is an input device to substitute for input keys, a keyboard, and a mouse. A user can input data by directly touching a touch screen by using a hand or a stylus pen after the touch screen has been mounted on a screen apparatus. In this case, since the touch screen allows the user to intuitionally perform the work under a GUI (Graphic User Interface) environment, the touch screen is suitable for a portable input device. In addition, the touch screen has been extensively used in various fields such as computer simulation application fields, office automation application fields, education application fields, and game application fields.

The input device employing the touch screen scheme basically includes a touch panel attached to a monitor, a controller, a device driver, and application programs. The touch panel includes several layers including ITO glass and an ITO film, which are specially treated so that the touch panel can detect a user input signal. If a user touches the surface of the touch panel by using a hand or a stylus pen, a display position sensor can detect a touch position on the touch panel.

In the case of the touch screen using the touch panel, since the hand of the user or the stylus pen must make directly contact with the touch panel, the fingerprint of the user may remain on the surface of the touch panel, or the touch panel may be scratched. In addition, when the touch screen is applied to a large scale display, the touch screen may not be controlled in a remote place.

### SUMMARY OF THE INVENTION

Accordingly, the present invention has been made keeping in mind the above problems occurring in the related art, and an object of the present invention is to an optical touch panel which can be optically touched by an infrared light in a remote place without a physical contact.

In order to accomplish the above object, according to one aspect of the present invention, there is provided an optical touch panel including a light transmission screen imaging an infrared light incident into a front surface thereof and scattering the infrared light along the front surface, and transmitting a visible light incident into a rear surface thereof to the front surface, a first infrared light sensor module provided at a lateral side of the light transmission screen and including a plurality of infrared light sensors to detect energy of the infrared light that has been scattered, a second infrared light sensor module provided at a lateral side of a light transmission panel in such a manner that a position of the second infrared light sensor module is different from a position of the first infrared light sensor module, and including a plurality of infrared light sensors to detect energy of the infrared light that has been scattered, and an operation module calculating an imaging position of the infrared light based on electrical signals output from the infrared light sensors of the first infrared light sensor module and electrical signals output from the infrared light sensors of the second infrared light sensor module.

In the above structure, the operation module selects an infrared light sensor outputting an electrical signal stronger than electrical signals of surrounding infrared light sensors from among the infrared light sensors of the first infrared light sensor module to detect a first input path of energy of a scattered infrared light input into the selected infrared light sensor, and selects an infrared light sensor outputting an electrical signal stronger than electrical signals of surrounding infrared light sensors from among the infrared light sensors of the second infrared light sensor module to detect a second input path of energy of a scattered infrared light input into the selected infrared light sensor, thereby calculating an intersection of the first input path of the infrared light energy and the second input path of the infrared light energy.

In the above structure, the infrared light sensors include pixels.

In the above structure, the first infrared light sensor module is positioned at an upper left corner of the light transmission screen, and the second infrared light sensor module is positioned at an upper right corner of the light transmission screen.

The optical touch panel further includes a third infrared light sensor module positioned at a lower corner of the light transmission screen.

In order to accomplish the above object, according to another aspect of the present invention, there is provided an optical touch panel including a light transmission screen imaging an infrared light incident into a front surface thereof to scatter the infrared light along the front surface, and transmitting a visible light incident into a rear surface thereof to the front surface, a first group of infrared light sensors distributed lengthwise along a lateral side of the light transmission screen to detect the energy of the scattered infrared light, a second group of infrared light sensors distributed widthwise along a lateral side of the light transmission screen to detect the energy of the infrared light, and an operation module calculating an imaging position of the infrared light based on electrical signals output from the first group of the infrared light sensors and electrical signals output from the second group of the infrared light sensors.

In the above structure, the operation module selects an infrared light sensor outputting an electrical signal stronger than electrical signals of surrounding infrared light sensors from among the first group of the infrared light sensors to detect a first input path of energy of a scattered infrared light input into the selected infrared light sensor, and selects an infrared light sensor outputting an electrical signal stronger than electrical signals of surrounding infrared light sensors from among the second group of the infrared light sensors to detect a second input path of energy of a scattered infrared light input into the selected infrared light sensor, thereby calculating an intersection of the first input path of the infrared light energy and the second input path of the infrared light energy.

In order to accomplish the above object, according to still another aspect of the present invention, there is provided an optical touch panel including a light transmission screen including a transparent plate, small convex lenses arranged in a form of a lattice on the transparent plate, and an infrared light imaging surface formed on a focus of the convex lens to image an infrared light, which is incident into a front surface thereof, on the infrared light imaging surface, to scatter the infrared light along the infrared light imaging surface, and to transmit a visible light, which is incident into a rear surface thereof, toward the front surface so that the visible light is imaged on a space at front of the convex lenses, a first infrared light sensor module provided at a lateral side of the light transmission screen and including a plurality of infrared light sensors to detect energy of the infrared light that has been scattered along the infrared light imaging surface, a second infrared light sensor module provided at a lateral side of a light transmission panel in such a manner that a position of the second infrared light sensor module is different from a position of the first infrared light sensor module, and including a plurality of infrared light sensors to detect energy of the infrared light that has been scattered along the infrared light imaging surface, and an operation module calculating an imaging position of the infrared light based on electrical signals output from the infrared light sensors of the first infrared light sensor module and electrical signals output from the infrared light sensors of the second infrared light sensor module.

In the above structure, the operation module selects an infrared light sensor outputting an electrical signal stronger than electrical signals of surrounding infrared light sensors from among the infrared light sensors of the first infrared light sensor module to detect a first input path of energy of a scattered infrared light input into the selected infrared light sensor, and selects an infrared light sensor outputting an electrical signal stronger than electrical signals of surrounding infrared light sensors from among the infrared light sensors of the second infrared light sensor module to detect a second input path of energy of a scattered infrared light input into the selected infrared light sensor, thereby calculating an intersection of the first input path of the infrared light energy and the second input path of the infrared light energy.

In the above structure, the infrared light sensors include pixels.

In the above structure, the first infrared light sensor module is positioned at an upper left corner of the light transmission screen, and the second infrared light sensor module is positioned at an upper right corner of the light transmission screen.

The optical touch panel may further include a third infrared light sensor module positioned at a lower corner of the light transmission screen.

Although the present invention has been described in terms of the infrared light, the present invention is not limited to the infrared light. In other words, a visible light having a specific wavelength is available, and a visible light representing brightness stronger than that of surroundings is available.

When the visible light having the specific wavelength is used, or when the visible light representing brightness stronger than that of the surroundings is used, the above object of the present invention is accomplished by providing the structure including a light transmission screen imaging a light incident into a front surface thereof and scattering the light along the front surface, and transmitting a visible light incident into a rear surface thereof to the front surface, a first light sensor module provided at a lateral side of the light transmission screen and including a plurality of light sensors to detect energy of the light that has been scattered, a second light sensor module provided at a lateral side of a light transmission panel in such a manner that a position of the second light sensor module is different from a position of the first light sensor module, and including a plurality of light sensors to detect energy of the light that has been scattered, and an operation module calculating an imaging position of the light based on electrical signals output from the light sensors of the first light sensor module and electrical signals output from the light sensors of the second light sensor module.

In the above structure, the operation module selects a light sensor outputting an electrical signal stronger than electrical signals of surrounding light sensors from among the light sensors of the first light sensor module to detect a first input path of energy of scattered light input into the selected light sensor, and selects a light sensor outputting an electrical signal stronger than electrical signals of surrounding light sensors from among the light sensors of the second light sensor module to detect a second input path of energy of a scattered light input into the selected light sensor, thereby calculating an intersection of the first input path of the light energy and the second input path of the light energy.

In the above structure, the infrared light sensors include pixels.

In the above structure, the first light sensor module is positioned at an upper left corner of the light transmission screen, and the second light sensor module is positioned at an upper right corner of the light transmission screen.

The optical touch panel may further include a third light sensor module positioned at a lower corner of the light transmission screen.

In addition, in order to accomplish the above object, according to still another aspect of the present invention, there is provided an optical touch panel including a light transmission screen imaging an light incident into a front surface thereof to scatter the light along the front surface, and transmitting a visible light incident into a rear surface thereof to the front surface, a first group of light sensors distributed lengthwise along a lateral side of the light transmission screen to detect the energy of the scattered light, a second group of light sensors distributed widthwise along a lateral side of the light transmission screen to detect the energy of the light, and an operation module calculating an imaging position of the light based on electrical signals output from the first group of the light sensors and electrical signals output from the second group of the light sensors.

In the above structure, the operation module selects an light sensor outputting an electrical signal stronger than electrical signals of surrounding light sensors from among the first group of the light sensors to detect a first input path of energy of a scattered light input into the selected light sensor, and selects an light sensor outputting an electrical signal stronger than electrical signals of surrounding light sensors from among the second group of the light sensors to detect a second input path of energy of a scattered light input into the selected light sensor, thereby calculating an intersection of the first input path of the light energy and the second input path of the light energy.

In addition, in order to accomplish the above object, according to still another aspect of the present invention, there is provided an optical touch panel including a light transmission screen including a transparent plate, small convex lenses arranged in a form of a lattice on the transparent plate, and a light imaging surface formed on a focus of the convex lens, to image a light, which is incident into a front surface thereof, on the light imaging surface, to scatter the light along the light imaging surface, and to transmit a visible light, which is incident into a rear surface thereof, toward the front surface so that the visible light is imaged on a space at front of the convex lenses, a first light sensor module provided at a lateral side of the light transmission screen and including a plurality of light sensors to detect energy of the light that has been scattered along the light imaging surface, a second light sensor module provided at a lateral side of a light transmission panel in such a manner that a position of the second light sensor module is different from a position of the first light sensor module, and including a plurality of light sensors to detect energy of the light that has been scattered along the light imaging surface and an operation module calculating an imaging position of the light based on electrical signals output from the light sensors of the first light sensor module and electrical signals output from the light sensors of the second light sensor module.

In the above structure, the operation module selects a light sensor outputting an electrical signal stronger than electrical signals of surrounding light sensors from among the light sensors of the first light sensor module to detect a first input path of energy of scattered light input into the selected light sensor, and selects a light sensor outputting an electrical signal stronger than electrical signals of surrounding light sensors from among the light sensors of the second light sensor module to detect a second input path of energy of a scattered light input into the selected light sensor, thereby calculating an intersection of the first input path of the light energy and the second input path of the light energy.

As described above, according to the present invention, since it is possible to detect positions in which an infrared light or a visible light projected from a remove place is scattered and collides on a touch panel or a transparent touch sheet, the optical touch panel, which can be optically touched without a physical touch, can be provided.

### BRIEF DESCRIPTION OF THE DRAWINGS

FIG. 1 is a view showing an optical touch panel installed on a front surface of a monitor according to a first embodiment of the present invention;

FIG. 2 is a view showing the optical touch panel separated from the monitor according to the first embodiment of the present invention;

FIG. 3 is a sectional view taken along line III-III′ of FIG. 2;

FIG. 4 is a view showing one example of the infrared light sensor module;

FIG. 5 is a virtual division view of an infrared light scattering screen on the basis of an infrared light sensor module installed in the vicinity of the upper left corner of a frame;

FIG. 6 is a view showing an infrared light imaged on the surface of a transparent plate and radially scattered about an imaging position P;

FIG. 7 is a view showing intensities of infrared lights incident onto infrared light sensors of a left infrared light sensor module;

FIG. 8 is a view showing intensities of infrared lights incident onto infrared light sensors of a right infrared light sensor module;

FIG. 9 is a flowchart showing the operation of a micro-processor of an operation module;

FIG. 10 is a view showing a second embodiment of the present invention;

FIG. 11 is a perspective view showing a third embodiment of the present invention;

FIG. 12 is a front view showing the third embodiment of the present invention;

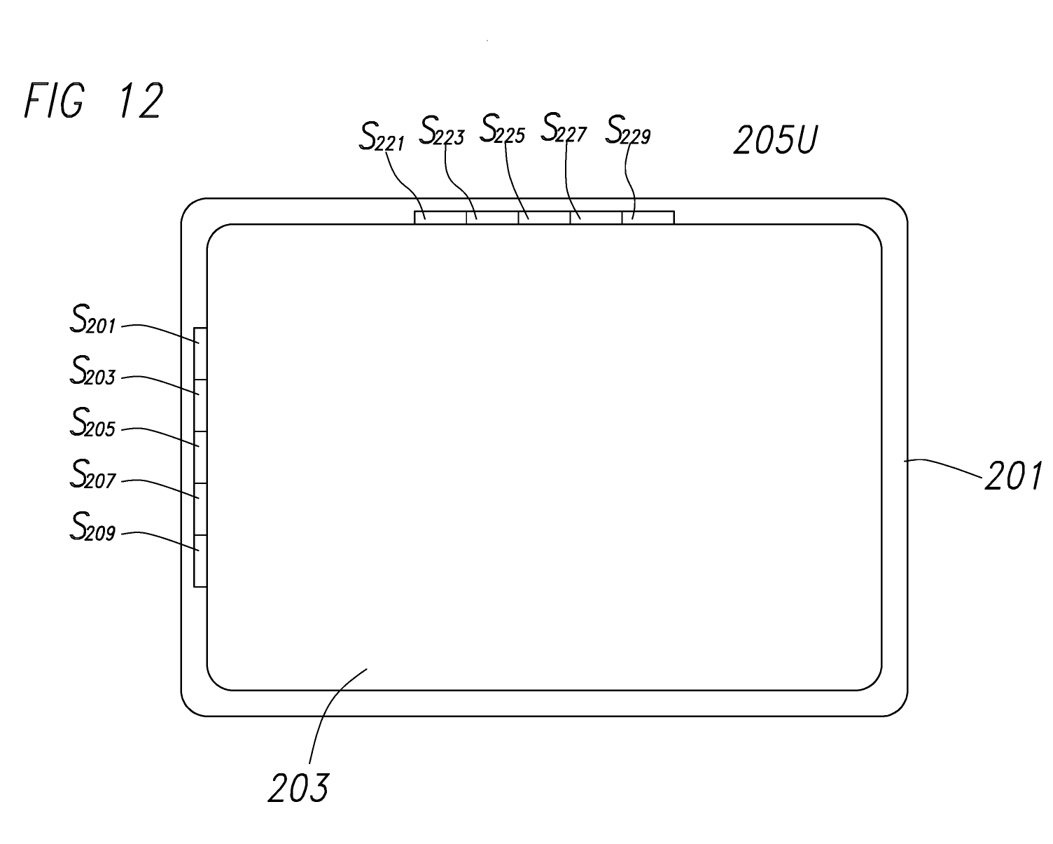

FIG. 13 is a view showing a fourth embodiment of the present invention;

FIG. 14 is a partially-cut sectional view of FIG. 13; and

FIG. 15 is a partial enlarged view of FIG. 14.

### DETAILED DESCRIPTION OF THE INVENTION

Hereinafter, the present invention will be described in detail with reference to accompanying drawings.

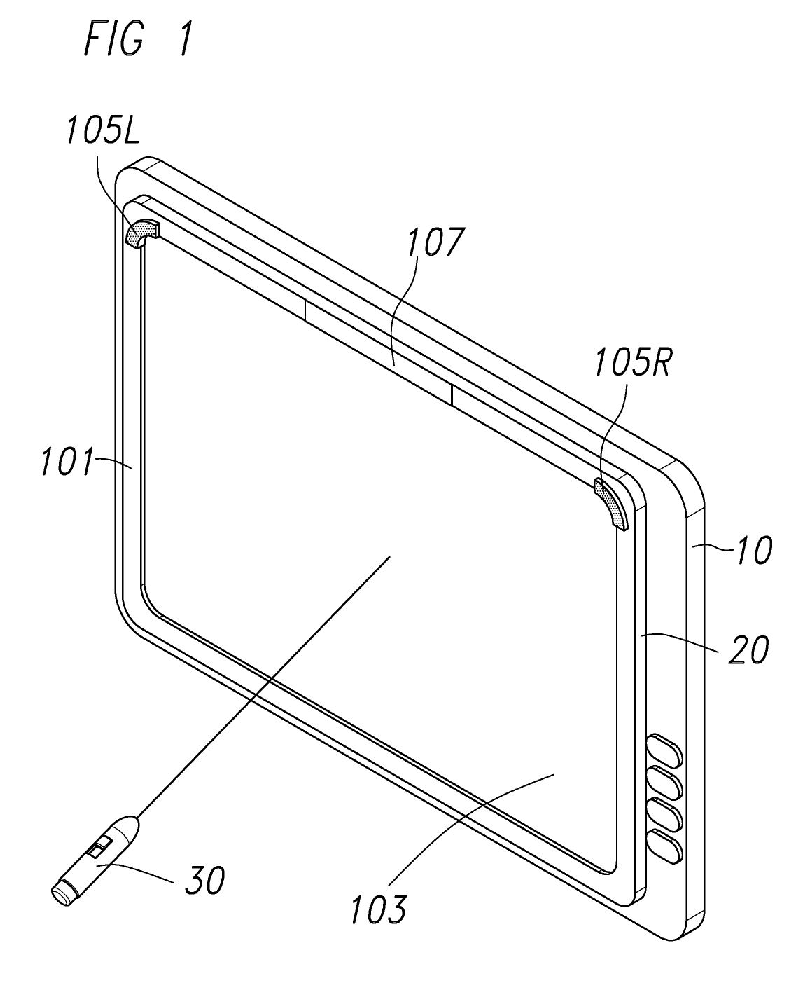

FIG. 1 is a view showing an optical touch panel installed on a front surface of a monitor according to a first embodiment of the present invention.

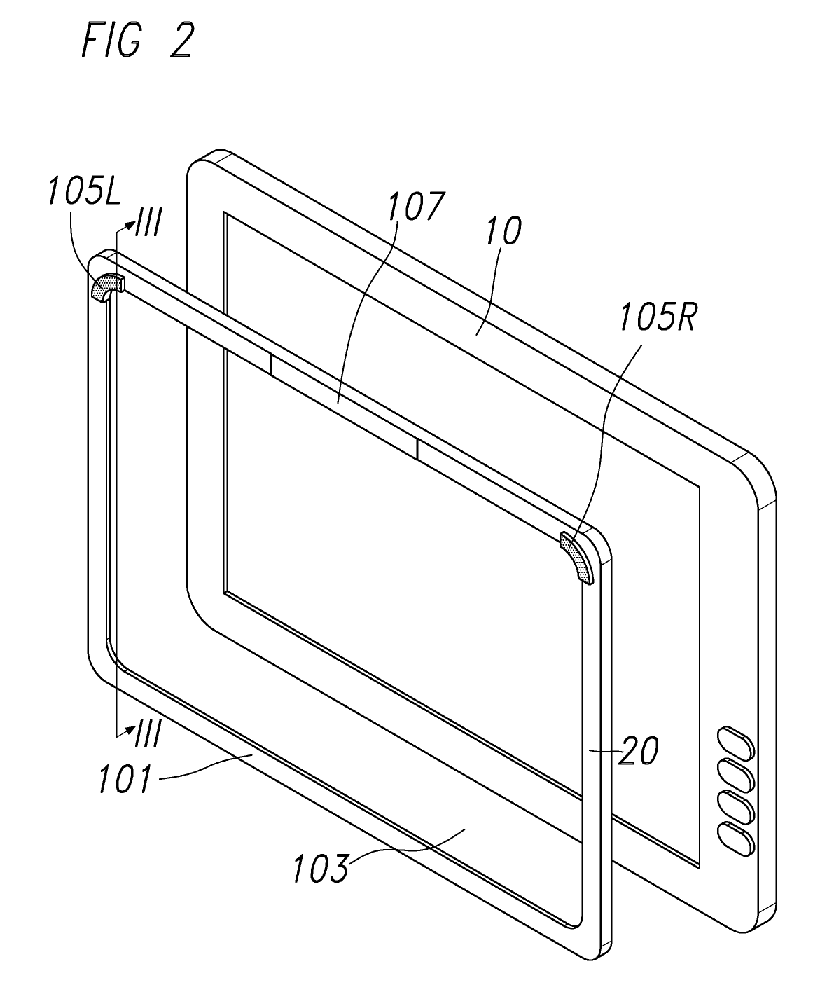

FIG. 2 is a view showing the optical touch panel separated from the monitor according to the first embodiment of the present invention.

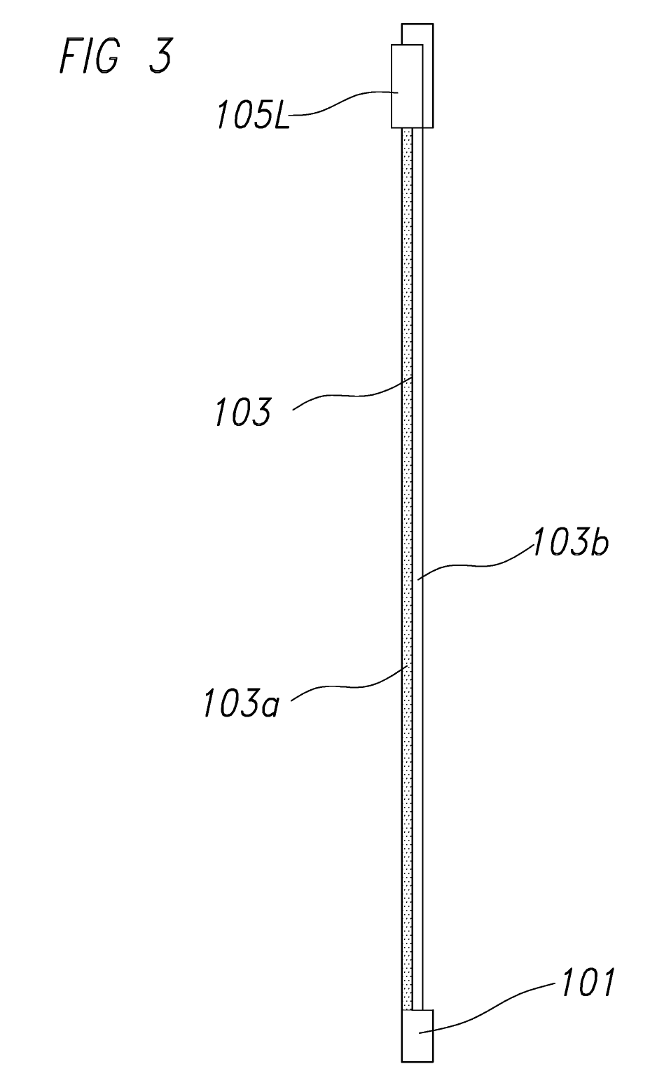

FIG. 3 is a sectional view taken along line III-III′ of FIG. 2.

Referring to FIG. 1, a reference numeral 10 represents an image display. A reference numeral 20 represents an optical touch panel according to the first embodiment of the present invention, and a reference numeral 30 represents an infrared beam pointer.

The optical touch panel 20 includes a frame 101, an infrared light scattering screen 103 fixed onto the frame 101, and left and right infrared light sensor modules 105L and 105R installed in the vicinity of upper left and right corners of the frame 101. In addition, an operation module 107 is provided at an upper middle portion of the frame 101.

As shown in FIG. 3, the infrared light scattering screen 103 includes a transparent plate 103a made of glass or plastic and an infrared light scattering film 103b attached to the surface of the transparent plate 103a. The infrared light scattering film 103b images external infrared light on the surface of the transparent plate 103a, and the infrared light imaged on the surface of the transparent plate 103a is radially scattered about the imaging position of the infrared light. The infrared light radially scattered about the imaging position on the surface of the transparent plate 103a is detected by sensors of the infrared light sensor module 105.

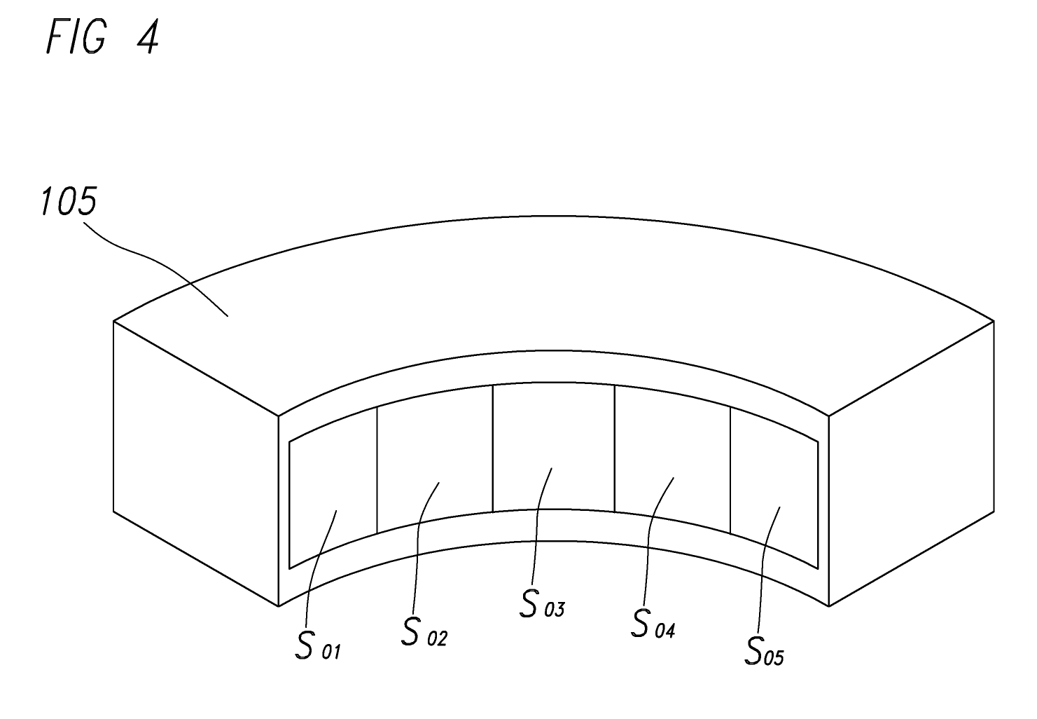

FIG. 4 is a view showing one example of the infrared light sensor module 105 to detect an infrared light. In the present description, infrared light sensor modules are assigned with reference numerals 105, 205, and 305. Further, English suffixes of the reference numerals 105, 205, and 305 represent the installation positions of the infrared light sensor modules 105, 205, and 305 for the purpose of explanation.

The infrared light sensor module 105 includes a plurality of infrared light sensors S01 to S05 received in a holder 105a. The infrared light sensors S01 to S05 are arranged in such a manner that normal lines extending from centers of the front surfaces of the infrared light sensors S01 to S05 are directed differently from each other.

Accordingly, the infrared light sensors can receive different optical energy when the scattered infrared light is incident onto the front surfaces of the infrared light sensors.

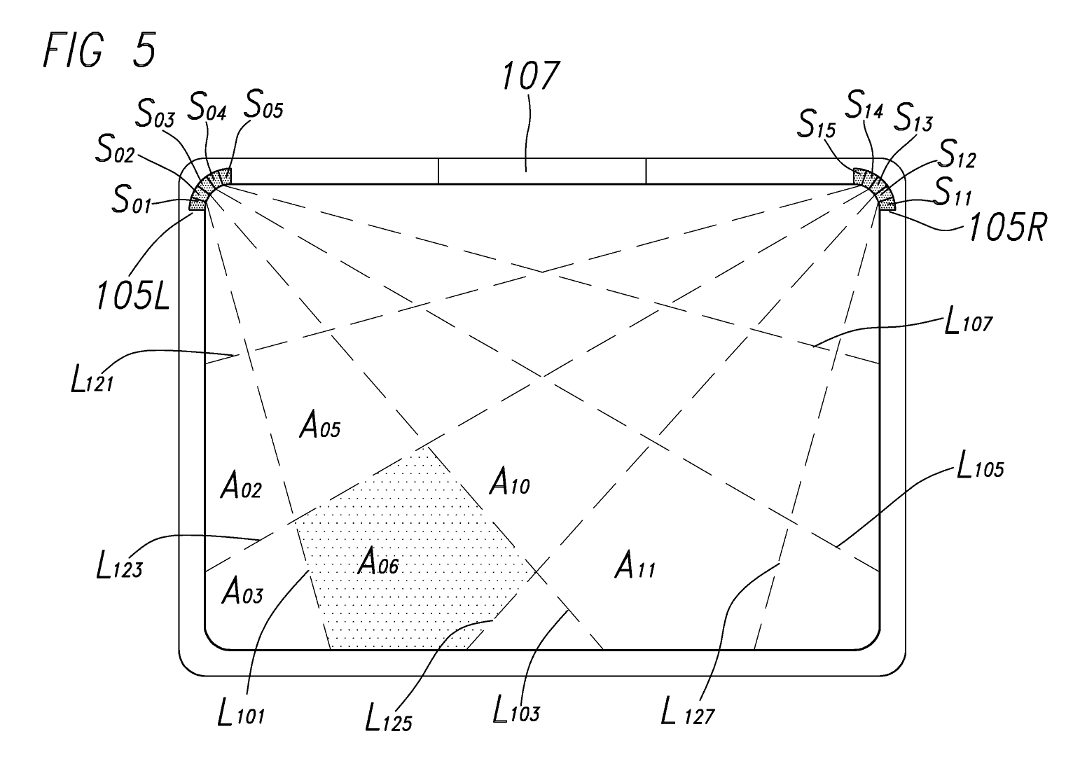

As shown in FIG. 5, the surface of the transparent plate 103a of the infrared light scattering screen 103 is virtually divided into small display sections A02, A03, A05, A06, A10, and A11 by crossing virtual lines L101 to L107 extending from the infrared light sensor module 105L installed in the vicinity of the upper left corner of the frame 101 and virtual lines L121 to L127 extending from the infrared light sensor module 105R installed in the vicinity of the upper right corner of the frame 101.

The infrared light sensors S01 to S05 of the left infrared light sensor module 105L correspond to sections between the virtual lines L101 to L107 extending from the left infrared light sensor module 105L, and the infrared light sensors S11 to S15 of the right infrared light sensor module 105R correspond to sections between the virtual lines L121 to L127 extending from the right infrared light sensor module 105R.

Therefore, each of the display sections A02, A03, A05, A06, A10, and A11 made by crossing the virtual lines L101 to L107 extending from the left infrared light sensor module 105L and the virtual lines L121 to L127 extending from the right infrared light sensor module 105R corresponds to one of the infrared light sensors S01 to S05 of the left infrared light sensor module 105L and one of the infrared light sensors S11 to S15 of the right infrared light sensor module 105R.

Each of the infrared light sensors S01 to S05 monitors the surface of the transparent plate 103a between the related virtual lines. The infrared light imaged on the surface of the transparent plate 103a is radially scattered about the imaging position of the infrared light. The infrared light sensors of one infrared light sensor module are arranged in such a manner that the infrared light sensor of monitoring a surface of the transparent plate 103a receives the greater optical energy than other infrared light sensors. The infrared light sensors S01 to S05 are arranged to receive the infrared light scattered from the related surface at a right angle or at a substantially right angle.

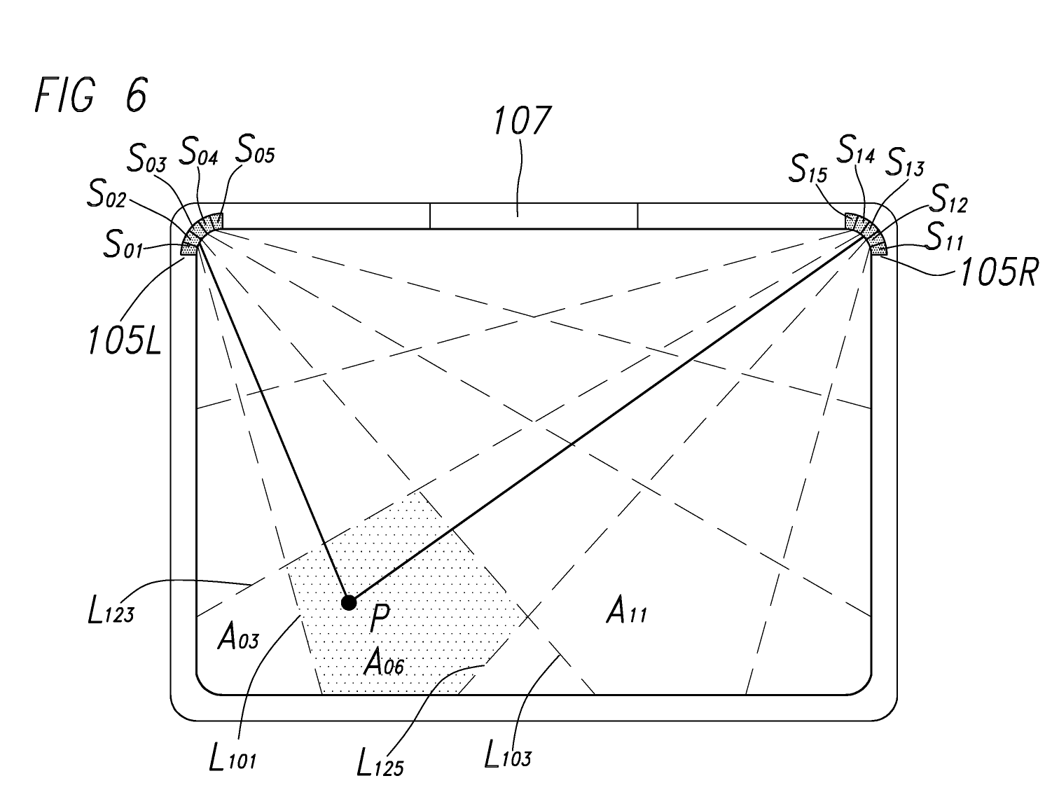

Hereinafter, the details thereof will be described with reference to FIGS. 6 to 8.

FIG. 6 is a view showing an infrared light imaged on the surface of the transparent plate 103a and radially scattered about an imaging position P.

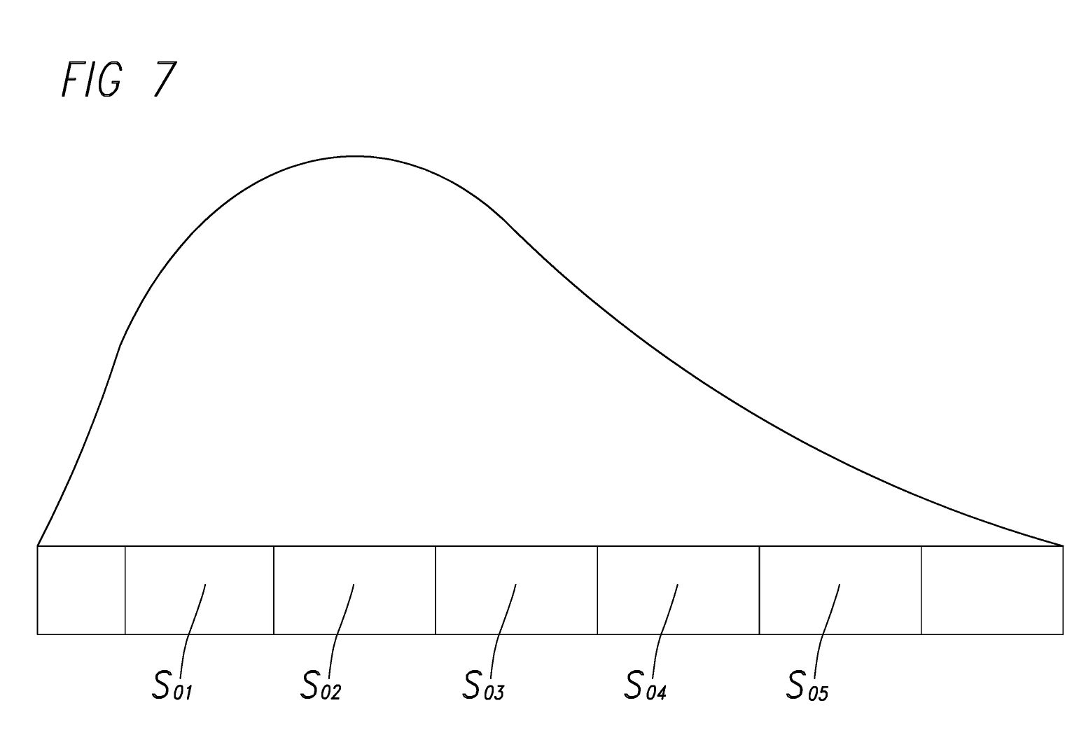

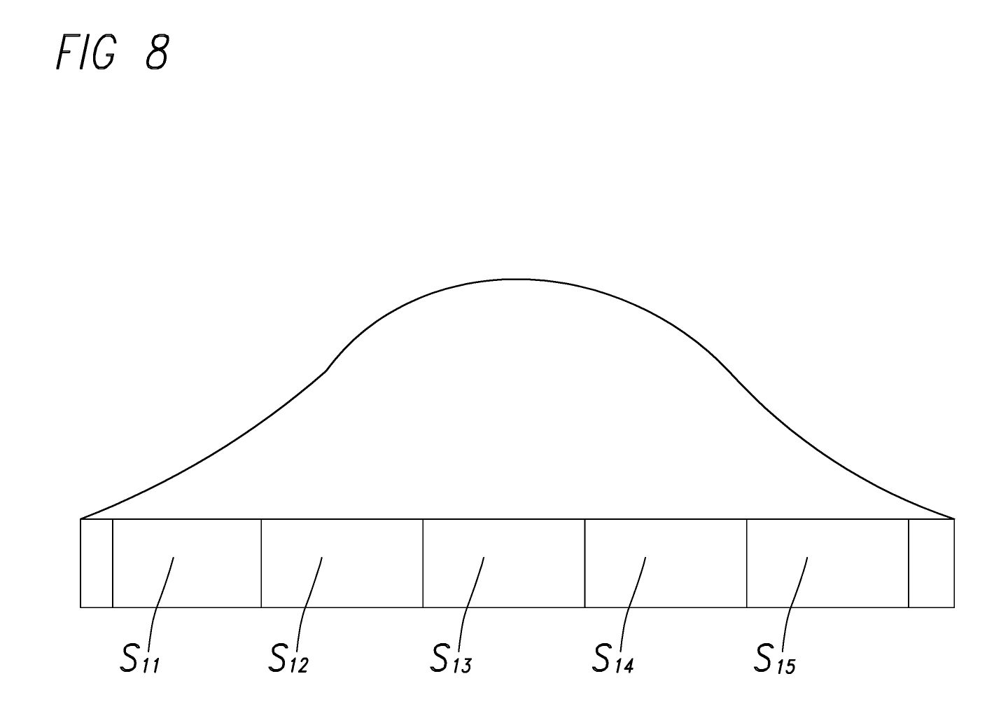

FIG. 7 is a view showing intensities of infrared lights incident onto the infrared light sensors S01 to S05 of the left infrared light sensor module, and FIG. 8 is a view showing intensities of infrared lights incident onto the infrared light sensors S11 to S15 of the right infrared light sensor module.

As shown in FIG. 6, after touching the imaging position P of the surface of the transparent plate 103a by using a laser beam pointer, the infrared light is imaged at the position P of the surface of the transparent pate 103a, and scattered radially about the imaging position P. A portion of infrared lights radially scattered is incident onto the infrared light sensors S01 to S05 of the left infrared light sensor module 105L and incident onto the infrared light sensors S11 to S15 of the right infrared light sensor module 105R.

As shown in FIG. 7, since the position P exists on the surface of the transparent plate 103a between the virtual lines L101 and L103, the optical energy of the light incident into the infrared light sensor S02 among the infrared light sensors S01 to S05 of the left infrared light sensor module 105L is remarkably greater than those of surrounding sensors. In addition, since the position P exists on the surface of the transparent plate 103a between the virtual lines L123 and L125, the optical energy of the light incident onto the infrared light sensor S13 among the infrared light sensors S11 to S15 of the right infrared light sensor module 105R is remarkably greater than those of the surrounding sensors as shown in FIG. 8.

Therefore, the position of the surface of the transparent plate 103a touched by a laser beam pointer exists in the display section A06 defined by the virtual lines L101 and L103, which correspond to the infrared light sensor S02 to detect the infrared light incident with optical energy remarkably greater than those of the surrounding sensors among the infrared light sensors S01 to S05 of the left infrared light sensor module 105L, and the virtual lines L123 and L125 corresponding to the infrared light sensor S03 to detect the infrared light incident with optical energy remarkably greater than those of surrounding sensors among the infrared light sensors S11 to S15 of the right infrared light sensor module 105R.

Therefore, if infrared light sensors of the left and right infrared light sensor module 105L and 105R, which detect infrared light incident with optical energy remarkably greater than those of surrounding sensors, are found out, a section between the virtual lines, which correspond to the infrared light sensor of the left infrared light sensor module 105L to detect the infrared light incident with optical energy greater than those of the surrounding sensors, and a section between the virtual lines corresponding to the infrared light sensor of the right infrared light sensor module 105R to detect the infrared light incident with optical energy greater than those of the surrounding sensors can be calculated, and the small display section A06 defined by the virtual lines and optically touched can be found out.

The infrared light sensors may include image sensors such as CMOSs or CODs provided in the form of pixels.

The image sensors such as the CMOSs or the CCDs covert received optical energy into electrical signals different from each other according to the received optical energy as shown in FIGS. 7 and 8.

The infrared light sensor to receive infrared light on the front surface thereof at a right angle or at a substantially right angle receives the strongest optical energy, and outputs electrical signals according to the optical energy to the operation module 107.

The operation module 107 determines that the infrared light is imaged between virtual lines corresponding to the left infrared light sensor to output an electrical signal remarkably stronger than those of surrounding sensors among electrical signals received therein from the infrared light sensors S01 to S05 of the left infrared light sensor module 105L.

In addition, the operation module 107 determines that the infrared light is imaged between virtual lines corresponding to the right infrared light sensor to output an electrical signal remarkably stronger than those of surrounding sensors, among electrical signals received therein from the infrared light sensors S11 to S15 of the right infrared light sensor module 105R.

Therefore, if the left infrared light sensor to send the electrical signal remarkably stronger than electrical signals of surrounding sensors and the right infrared light sensor to send the electrical signal remarkably stronger than the electrical signals of surrounding sensors are determined, the operation module 107 performs an operation with respect to the intersection between the virtual lines corresponding to the left infrared light sensor, which have sent the electrical signal stronger than the electrical signals of the surrounding sensors, and the virtual lines corresponding to the right infrared light sensor which has sent the electrical signal stronger than the electrical signals of the surrounding sensors and determines the intersection as the imaging position of infrared light.

If the imaging position of the infrared light is determined, it is determined that a user selects the imaging position.

The operation module 107 is connected to the left and right infrared light sensor modules 105L and 105R, and can calculate the coordinates of the scattering point of an infrared light by using the information about the scattering position of the infrared light based on the electrical signals from the left and right infrared light sensor modules 105L and 105R. The operation module 107 includes a micro-process to calculate the coordinates of the scattering position of the infrared light.

The operation module 107 can calculate the coordinates of the scattering position of the infrared light through various schemes. The operation module 107 is connected to a central processing unit of an application for the optical touch panel to transfer the operating state of the optical touch panel to the application.

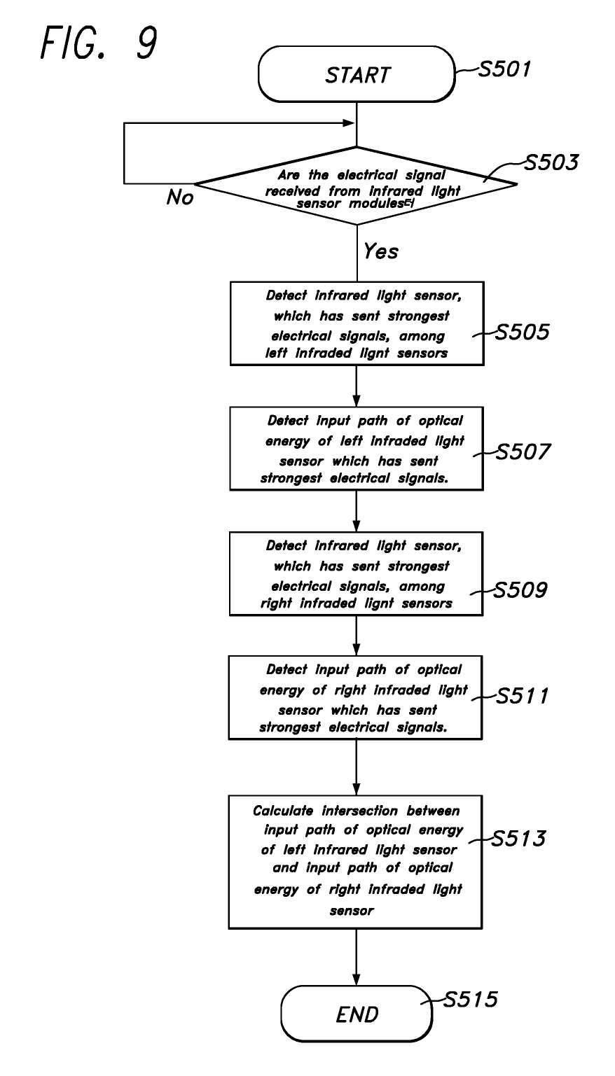

FIG. 9 is a flowchart showing the operation of the micro-processor of the operation module.

If the operation of the micro-process is commenced (step S501), the micro-processor performs step S503 to monitor if the electrical signals are received from the left and right infrared light sensor modules 105L and 105R.

If the electrical signals are not input from the left and right infrared light sensor modules 105L and 105R, the micro-processor is in a stand-by state until electrical signals are input.

If the micro-processor determines that the electrical signals are input from the left and right infrared light sensor modules 105L and 105R in step S503, the micro-processor performs step S505 to find an infrared light sensor, which has sent an electrical signal remarkably stronger than electrical signals of surrounding sensors, from among the left infrared light sensors. Then, the micro-processor performs step S507 to detect the path of the optical energy input into the left infrared light sensor which has sent the electrical signal remarkably stronger than the electrical signals of the surrounding sensors.

The input path is referred to as a first input path of the optical energy of the infrared light for the purpose of explanation, and the first input path is uniquely determined as one of the virtual lines L101 to L107 extending from the left light sensor module 105L due to the linearity of light.

In addition, the micro-processor performs step S509 to detect the infrared light sensor which has sent an electrical signal even stronger than electrical signals of surrounding sensors among the right infrared light sensors. Then, the micro-processor performs step S511 to detect the path of the optical energy input into the right infrared light sensor which has sent an electrical signal even stronger than electrical signals of surrounding sensors.

The input path is referred to as the second input path of the infrared light energy for the purpose of explanation, and the second input path is uniquely determined as one of the virtual lines L121 to L127 extending from the right infrared light sensor 105R.

If the first input path of the first infrared light energy and the second input path of the second infrared light energy have been detected, the micro-process performs step S513 to perform an operation for the intersection between the first and second input path of the infrared light energy so that the intersection is determined as the imaging point of the infrared light and to stop the operation thereof.

Although not described additionally, it is natural that the imaging position of the infrared light should be transferred to the controller, the device driver, and the application program if the imaging position of the infrared light is determined.

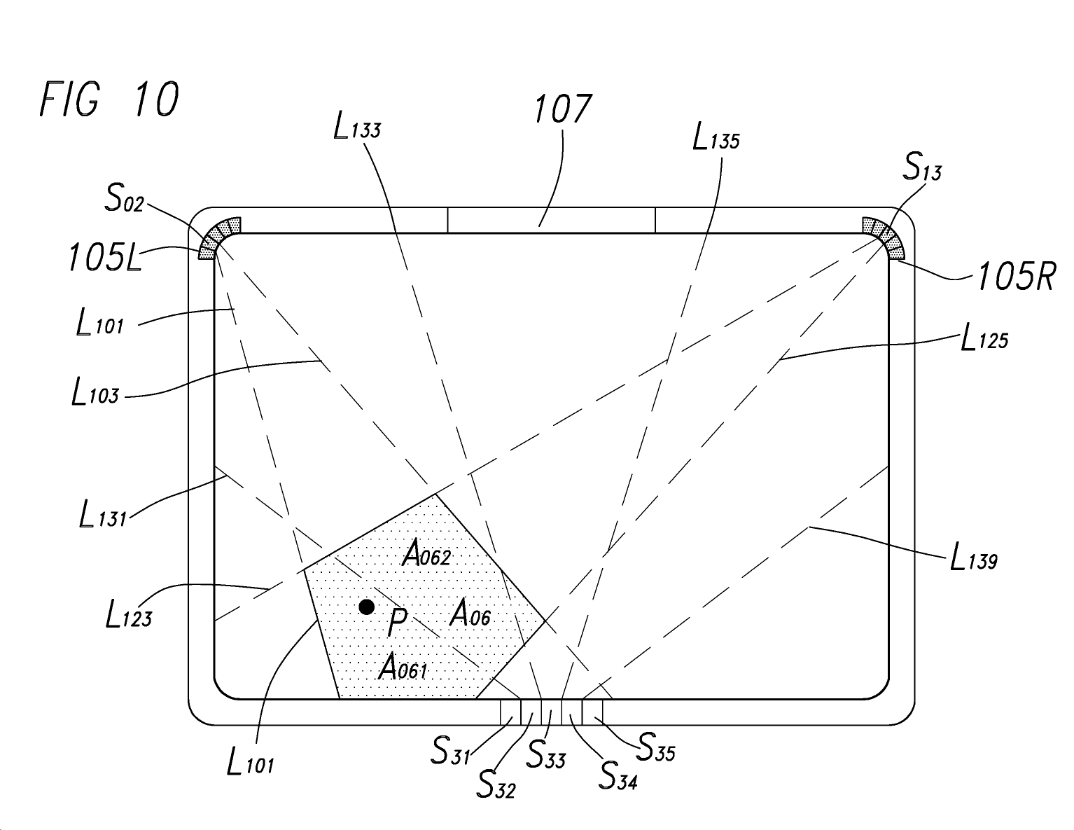

FIG. 10 is a view showing the second embodiment of the present invention.

According to the first embodiment, infrared light sensor modules to detect optical energy through the imaging of the infrared light of the infrared light scattering screen 103 are positioned in the vicinity of left and right corners of the frame. According to the first embodiment, if the imaging position of the infrared light exists at the lower portion of the light scattering screen as shown in FIG. 6, the area corresponding to the right and left infrared light sensors is expanded, so that errors may occur when determining the imaging position of the infrared light, that is, the touch position of the infrared light.

In order to solve the above problem, the lower surface of the optical touch panel 20 is more subdivided by installing another infrared light sensor module 105C at a lower portion of the frame 101 of the optical touch panel 20 as shown in FIG. 10. Accordingly, although the imaging position of the infrared light exists at the lower portion of the infrared light scattering screen, the error can be reduced when determining the touch position of the light.

As shown in FIG. 10, infrared sensors S31 to S35 of the infrared light sensor module 105C correspond to an intersection between virtual lines L131 to L137 extending from the center of the infrared light sensor module 105C.

Therefore, the display section A06 defined by the virtual lines L101 and L103 and the virtual lines L123 and L125 is more subdivided by the virtual lines L131 to L133 extending from the infrared light sensor module 105C to form smaller display sections A061 and A062.

In this case, the smaller display section can be detected by selectively using two or three infrared light sensors, which receive stronger optical energy, from among the infrared light sensors of the left infrared light sensor module 105L, the right infrared light sensor module 105R, and the lower infrared light sensor module 105C.

If a little amount of the optical energy is input into the infrared light sensors, the infrared light sensors may rarely detect the optical energy. This problem may become serious if the optical touch panel has the great size. Thus, a greater number of infrared light sensor modules 105C are installed on the frame of the optical touch panel so that imaging positions of the infrared light can be detected regardless of the imaging positions of the infrared light in the frame of the optical touch panel.

Similarly to the first embodiment, the operation module 107 can calculate the imaging position of the infrared light by calculating the intersection between paths extending from front surfaces of one infrared light sensor and another infrared light sensor, which have sent electrical signals remarkably stronger than those of surrounding light sensors.

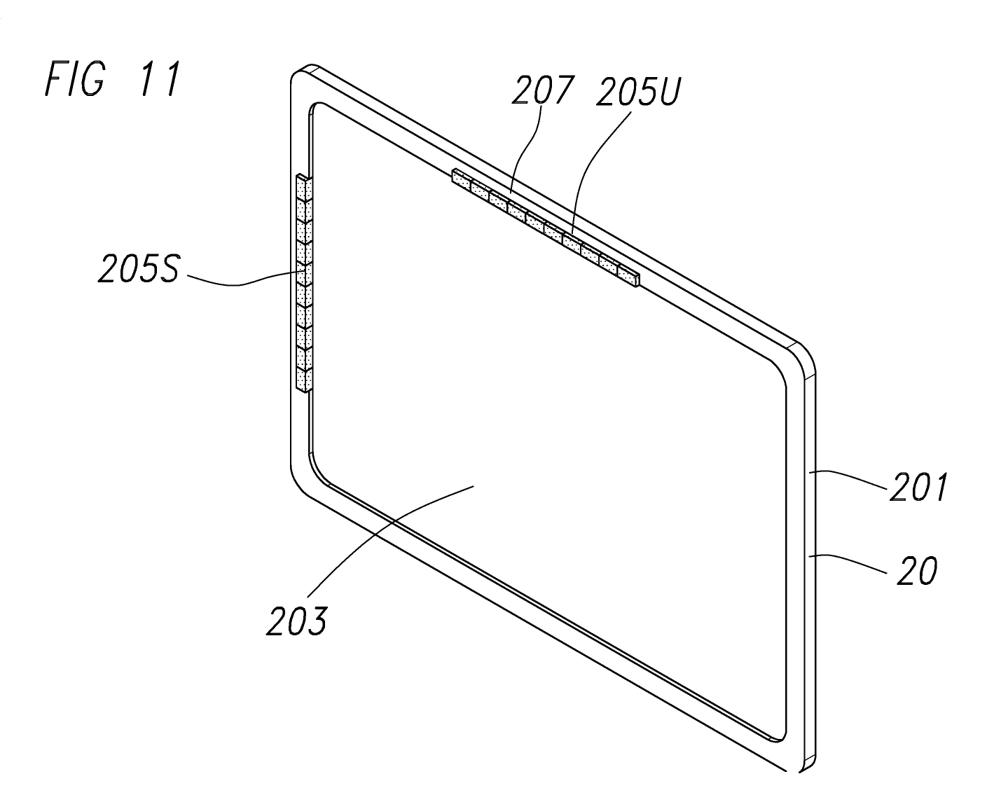

FIG. 11 is a view showing a third embodiment of the present invention.

According to the first and second embodiments, the infrared light sensor modules to detect optical energy based on the imaging of the infrared light of the infrared light scattering screen 103 are positioned in the vicinity of the left and right corners of the frame. In this case, the infrared light sensors S01 to S05 of the left infrared light sensor module 105L are concentrically installed in one place.

According to the third embodiment, infrared light sensors of infrared light sensor modules 205S and 205U are provided at an upper frame edge and a lateral frame edge, respectively.

In this case, the operation module 107 performs an operation for the intersection between paths extending from the front surface of an infrared light sensor, which has sent the strongest electrical signal and another infrared light sensor, which has sent an electrical signal even stronger than those of surrounding light sensors, to calculate the imaging position of the infrared light.

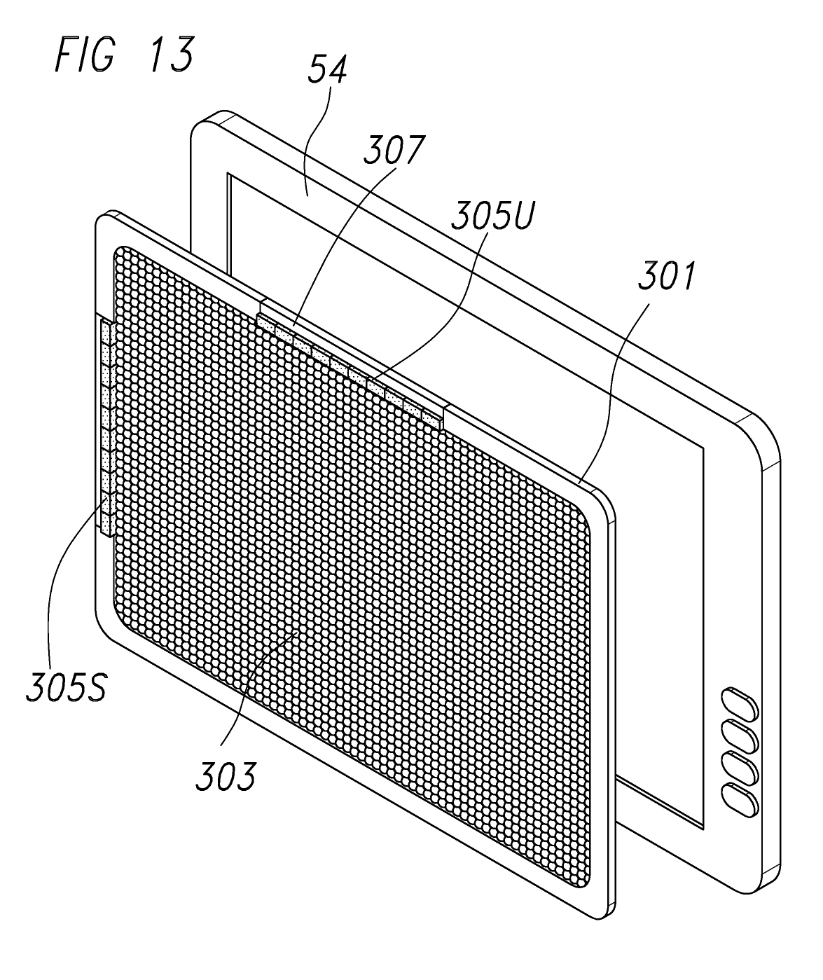

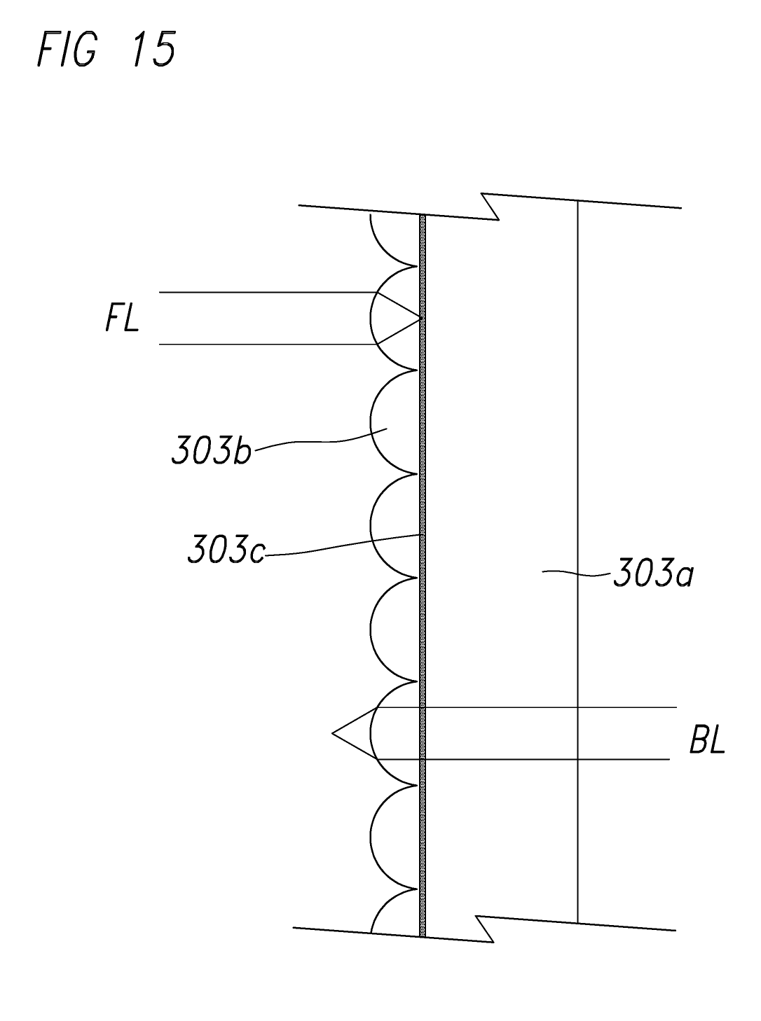

FIGS. 13 to 15 are views showing a fourth embodiment of the present invention.

According to the fourth embodiment, an infrared light scattering screen 303 has a structure in which small convex lenses are arranged on the whole surface thereof in the form of a lattice to transmit internal visible light to the outside, and to scatter external infrared light.

In the infrared light scattering screen 303 according to the fourth embodiment, the whole surface of a transparent plate 303a has a structure in which small convex lenses 303b having the same focal length are arranged in the form of a lattice, and the focuses of the convex lenses 303b may form the imaging surface of the infrared light.

Then, the infrared light sensors S01 detect the optical energy of the image focused on the imaging surface by the infrared light.

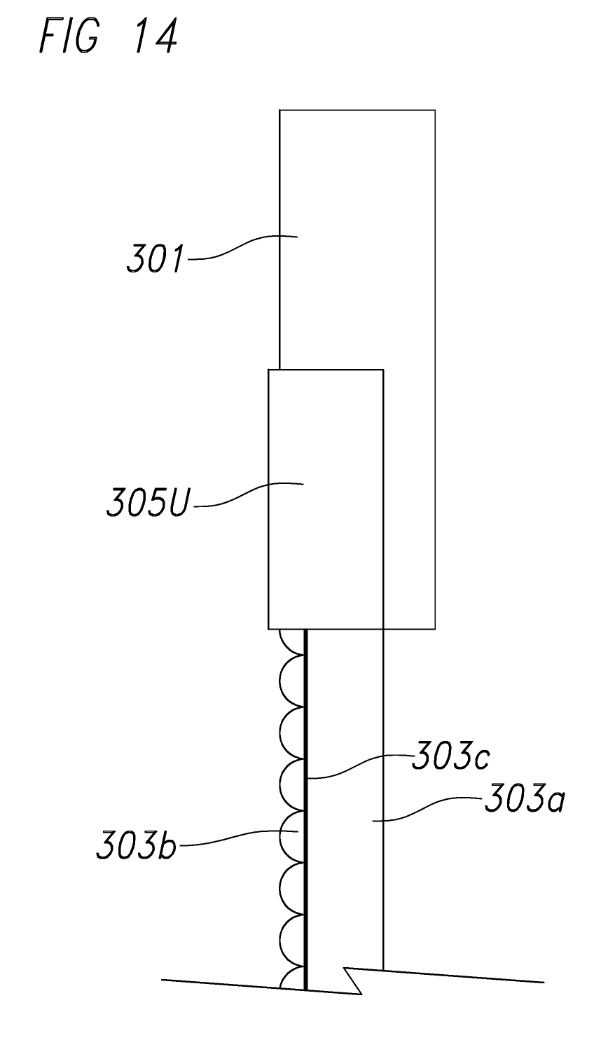

FIG. 13 is a partial enlarged view of FIG. 14.

The infrared light incident into the front surface of the infrared light scattering screen 303 is collected by the convex lenses 303b and concentrated on the focuses of corresponding convex lenses 303b. The focuses of the convex lenses 303b form an imaging surface so that the infrared light collected on the focuses of the convex lens is imaged.

However, a visible light incident into the rear surface of the infrared light scattering screen 303 is collected on the focuses of the front surfaces of the convex lenses 303b. However, since an empty space exists at the front of the infrared light scattering screen 303, the visible light is not imaged.

According to the embodiment, although the optical touch panel is attached to a display apparatus, since an infrared light is used instead of a physical contact, the surface of the display apparatus is not scratched undesirably. In addition, a touch screen function can be conveniently performed in a remote plate.

Preferably, a beam pointer used in the present invention projects an infrared light and a visible light.

According to the present invention, the infrared light sensor detects scattered infrared lights and calculates a touch position. In this case, a user cannot sense the infrared light by the naked eyes, so that the user cannot recognize the touch position. Accordingly, a portion touched by the infrared light is touched by a visible light, so that the user can easily recognize the touched position by the naked eyes.

Although the present invention has been described in terms of the infrared light, the present invention is not limited to the infrared light. In other words, a visible light having a specific wavelength is available, and a visible light representing brightness stronger than that of surroundings is available.

What is claimed is:

1. An optical touch panel comprising:
a light transmission screen imaging an infrared light incident into a front surface thereof and scattering the infrared light along the front surface, and transmitting a visible light incident into a rear surface thereof to the front surface;
a first infrared light sensor module provided at a lateral side of the light transmission screen and including a plurality of infrared light sensors to detect energy of the infrared light that has been scattered;
a second infrared light sensor module provided at a lateral side of a light transmission panel in such a manner that a position of the second infrared light sensor module is different from a position of the first infrared light sensor module, and including a plurality of infrared light sensors to detect energy of the infrared light that has been scattered; and
an operation module calculating an imaging position of the infrared light based on electrical signals output from the infrared light sensors of the first infrared light sensor module and electrical signals output from the infrared light sensors of the second infrared light sensor module.

2. The optical touch panel of claim 1, wherein the operation module selects an infrared light sensor outputting an electrical signal stronger than electrical signals of surrounding infrared light sensors from among the infrared light sensors of the first infrared light sensor module to detect a first input path of energy of a scattered infrared light input into the selected infrared light sensor, and selects an infrared light sensor outputting an electrical signal stronger than electrical signals of surrounding infrared light sensors from among the infrared light sensors of the second infrared light sensor module to detect a second input path of energy of a scattered infrared light input into the selected infrared light sensor, thereby calculating an intersection of the first input path of the infrared light energy and the second input path of the infrared light energy.

3. The optical touch panel of claim 2, wherein the infrared light sensors include pixels.

4. The optical touch panel of claim 3, wherein the first infrared light sensor module is positioned at an upper left corner of the light transmission screen, and the second infrared light sensor module is positioned at an upper right corner of the light transmission screen.

5. The optical touch panel of claim 4, further comprising a third infrared light sensor module positioned at a lower corner of the light transmission screen.

6. An optical touch panel comprising:
a light transmission screen imaging an infrared light incident into a front surface thereof to scatter the infrared light along the front surface, and transmitting a visible light incident into a rear surface thereof to the front surface;
a first group of infrared light sensors distributed lengthwise along a lateral side of the light transmission screen to detect the energy of the scattered infrared light;
a second group of infrared light sensors distributed widthwise along a lateral side of the light transmission screen to detect the energy of the infrared light; and
an operation module calculating an imaging position of the infrared light based on electrical signals output from the first group of the infrared light sensors and electrical signals output from the second group of the infrared light sensors.

7. The optical touch panel of claim 6, wherein the operation module selects an infrared light sensor outputting an electrical signal stronger than electrical signals of surrounding infrared light sensors from among the first group of the infrared light sensors to detect a first input path of energy of a scattered infrared light input into the selected infrared light sensor, and selects an infrared light sensor outputting an electrical signal stronger than electrical signals of surrounding infrared light sensors from among the second group of the infrared light sensors to detect a second input path of energy of a scattered infrared light input into the selected infrared light sensor, thereby calculating an intersection of the first input path of the infrared light energy and the second input path of the infrared light energy.

8. An optical touch panel comprising:
a light transmission screen including a transparent plate, small convex lenses arranged in a form of a lattice on the transparent plate, and an infrared light imaging surface formed on a focus of the convex lens to image an infrared light, which is incident into a front surface thereof, on the infrared light imaging surface, to scatter the infrared light along the infrared light imaging surface, and to transmit a visible light, which is incident into a rear surface thereof, toward the front surface so that the visible light is imaged on a space at front of the convex lenses;
a first infrared light sensor module provided at a lateral side of the light transmission screen and including a plurality of infrared light sensors to detect energy of the infrared light that has been scattered along the infrared light imaging surface;
a second infrared light sensor module provided at a lateral side of a light transmission panel in such a manner that a position of the second infrared light sensor module is different from a position of the first infrared light sensor module, and including a plurality of infrared light sensors to detect energy of the infrared light that has been scattered along the infrared light imaging surface; and
an operation module calculating an imaging position of the infrared light based on electrical signals output from the infrared light sensors of the first infrared light sensor module and electrical signals output from the infrared light sensors of the second infrared light sensor module.

9. The optical touch panel of claim 8, wherein the operation module selects an infrared light sensor outputting an electrical signal stronger than electrical signals of surrounding infrared light sensors from among the infrared light sensors of the first infrared light sensor module to detect a first input path of energy of a scattered infrared light input into the selected infrared light sensor, and selects an infrared light sensor outputting an electrical signal stronger than electrical signals of surrounding infrared light sensors from among the infrared light sensors of the second infrared light sensor module to detect a second input path of energy of a scattered infrared light input into the selected infrared light sensor, thereby calculating an intersection of the first input path of the infrared light energy and the second input path of the infrared light energy.

10. The optical touch panel of claim 9, wherein the infrared light sensors include pixels.

11. The optical touch panel of claim 10, wherein the first infrared light sensor module is positioned at an upper left corner of the light transmission screen, and the second infrared light sensor module is positioned at an upper right corner of the light transmission screen.

12. The optical touch panel of claim 11, further comprising a third infrared light sensor module positioned at a lower corner of the light transmission screen.

13. An optical touch panel comprising:
a light transmission screen imaging a light incident into a front surface thereof and scattering the light along the front surface, and transmitting a visible light incident into a rear surface thereof to the front surface;
a first light sensor module provided at a lateral side of the light transmission screen and including a plurality of light sensors to detect energy of the light that has been scattered;
a second light sensor module provided at a lateral side of a light transmission panel in such a manner that a position of the second light sensor module is different from a position of the first light sensor module, and including a plurality of light sensors to detect energy of the light that has been scattered; and
an operation module calculating an imaging position of the light based on electrical signals output from the light sensors of the first light sensor module and electrical signals output from the light sensors of the second light sensor module.

14. The optical touch panel of claim 13, wherein the operation module selects a light sensor outputting an electrical signal stronger than electrical signals of surrounding light sensors from among the light sensors of the first light sensor module to detect a first input path of energy of scattered light input into the selected light sensor, and selects a light sensor outputting an electrical signal stronger than electrical signals of surrounding light sensors from among the light sensors of the second light sensor module to detect a second input path of energy of a scattered light input into the selected light sensor, thereby calculating an intersection of the first input path of the light energy and the second input path of the light energy.

15. The optical touch panel of claim 14, wherein the infrared light sensors include pixels.

16. An optical touch panel comprising:
a light transmission screen including a transparent plate, small convex lenses arranged in a form of a lattice on the transparent plate, and a light imaging surface formed on a focus of the convex lens, to image a light, which is incident into a front surface thereof, on the light imaging surface, to scatter the light along the light imaging surface, and to transmit a visible light, which is incident into a rear surface thereof, toward the front surface so that the visible light is imaged on a space at front of the convex lenses;
a first light sensor module provided at a lateral side of the light transmission screen and including a plurality of light sensors to detect energy of the light that has been scattered along the light imaging surface;
a second light sensor module provided at a lateral side of a light transmission panel in such a manner that a position of the second light sensor module is different from a position of the first light sensor module, and including a plurality of light sensors to detect energy of the light that has been scattered along the light imaging surface; and
an operation module calculating an imaging position of the light based on electrical signals output from the light sensors of the first light sensor module and electrical signals output from the light sensors of the second light sensor module.
